(19) United States
(12) Patent Application Publication
(10) Pub. No.: US 2016/0350104 A1
(43) Pub. Date: Dec. 1, 2016

(54) COMPUTER SOFWARE BUILD MANAGEMENT

(71) Applicant: Microsoft Technology Licensing, LLC, Redmond, WA (US)

(72) Inventors: Christian Hofsetz, Redmond, WA (US); Kerry Young, Redmond, WA (US)

(21) Appl. No.: 14/721,228

(22) Filed: May 26, 2015

(51) Int. Cl. G06F 9/44

(52) U.S. Cl. CPC G06F 8/71

(57) ABSTRACT

Various techniques for computer software build management are disclosed herein. In one embodiment, a computer system includes a plurality of software builders communicatively coupled via a computer network. The plurality of software builders are individually configured to receive a change to be applied to a copy of source code of a software application, apply the received change to the synchronized copy of the source code, and independently perform a software build on the copy of the source code with the applied change for a computing platform. The copies of the source code and the changes applied at the plurality of builders are the same while the computing platforms at the plurality of builders are different from one another.

### BACKGROUND

When developing software applications, a team of software developers can first create a set of statements in source code designed to perform certain functionality. In certain implementations, a compiler can then be used to convert the statements in source code into machine codes executable by processors. In other implantations, an interpreter can execute the source codes directly without compilation by translating each statement into a sequence of subroutines already compiled into machine codes. In any of these implementations, the software developers may repeatedly revise and compile/interpret the statements in source code to ensure that the software applications can properly achieve intended functionality.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

When developing software applications with extensive complexity, a large number of software developers are often divided into teams, each tasked to develop a portion of the software applications. For example, teams can be organized as branches on a tree with each team tasked to develop a part or branch of a software application. The teams can then separately develop, debug, compile, and/or validate each branch of the software application. Software integrators can then assemble or integrate the separately developed branches into a main body of the software application.

However, such branch integration can be challenging. For instance, the separately developed branches often do not function properly with one another even though each part functions as intended. As a result, a team of dedicated software integrators may spend considerable amount of time (e.g., days or even weeks) attempting to integrate all the separately developed branches. If conflicts or issues among the branches cannot be resolved, one or more branches may be withdrawn from the main body of the software application and returned to a corresponding team for revision and retesting. The integration complexity can also delay changes made in a branch from reaching the main body of the software application. Thus, some integrated branches may include known issues such as test failures or quality problems. As such, fixes or code corrections may need to be applied to both a branch and the main body. The foregoing challenges with branch integration can become even more pronounced when the software application is designed for multiple computing platforms.

Several embodiments of the disclosed technology can address at least some of the foregoing difficulties by implementing one or more software builder sets each having multiple builders individually configured to directly apply changes to a main body of a software application. Each software builder can also be configured to separately compile, test, validate, and/or perform other suitable tasks to ensure proper functioning of the main body with the applied changes for a particular computing platform (e.g., Android) or flavors thereof (e.g., Android X86 or ARM). As such, changes to the main body can be continually tested. Any conflicts or issues related to particular changes can be identified during each software build for multiple computing platforms or flavors thereof. In certain embodiments, the software builders can publish results of each software build to teams of software developers. In other embodiments, the software builders can also incorporate tested changes into the main body of the software application in source code based on certain validation and/or quality criteria.

### BRIEF DESCRIPTION OF THE DRAWINGS

FIGS. 1A and 1B are schematic diagrams illustrating a computing framework for computer software build management in accordance with embodiments of the disclosed technology.

FIG. 2 is a block diagram showing software modules suitable for a software builder of FIG. 1 and in accordance with embodiments of the disclosed technology.

FIG. 3 is a flow diagram illustrating embodiments of a process of computer software build in accordance with embodiments of the disclosed technology.

FIG. 4 is a flow diagram illustrating embodiments of a process of preparing for a software build in accordance with embodiments of the disclosed technology.

FIG. 5 is a flow diagram illustrating embodiments of a process of applying changes for a software build in accordance with embodiments of the disclosed technology.

FIG. 6 is a flow diagram illustrating embodiments of a process of performing a software build in accordance with embodiments of the disclosed technology.

FIG. 7 is a schematic diagram illustrating a computing framework having multiple builder sets for computer software build management in accordance with embodiments of the disclosed technology.

FIG. 8 is a computing device suitable for certain components of the computing framework in FIG. 1.

### DETAILED DESCRIPTION

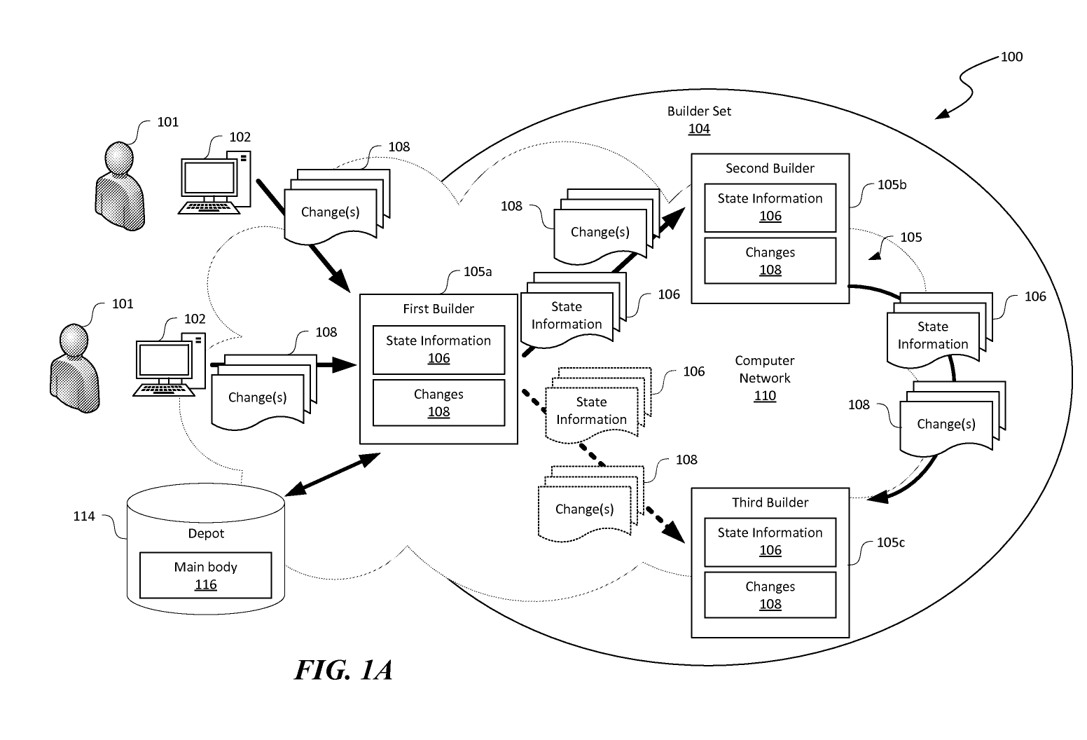

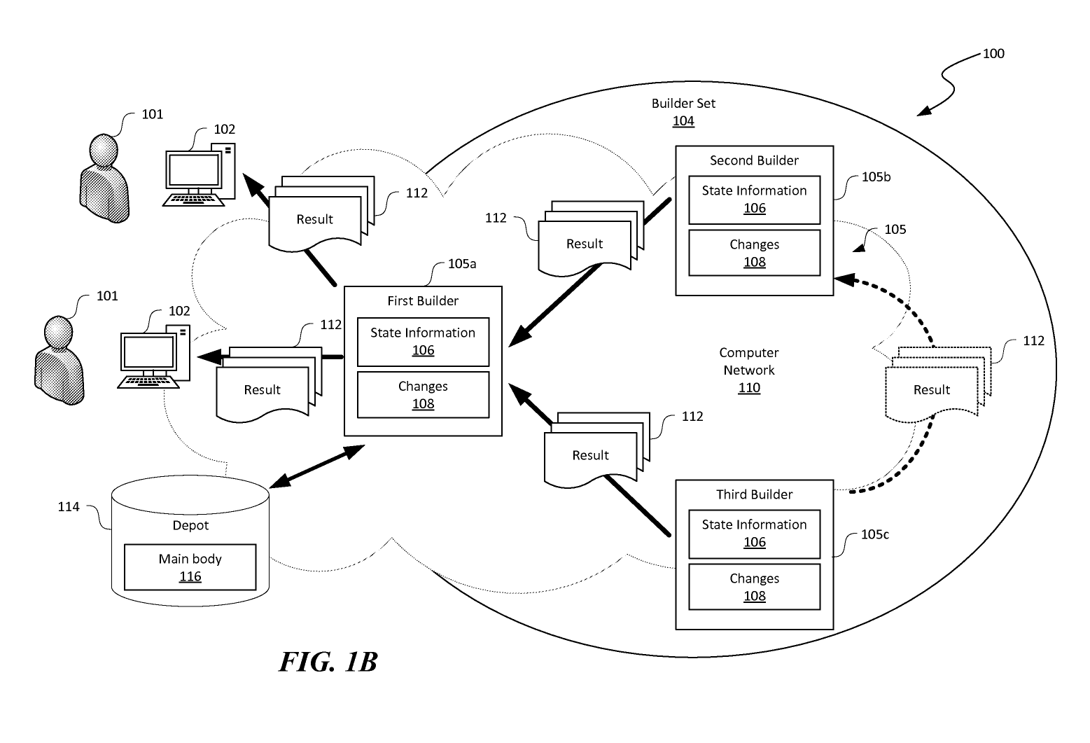

Certain embodiments of systems, devices, components, modules, routines, and processes for computer software build management are described below. In the following description, specific details of components are included to provide a thorough understanding of certain embodiments of the disclosed technology. A person skilled in the relevant art will also understand that the disclosed technology may have additional embodiments or may be practiced without several of the details of the embodiments described below with reference to FIGS. 1-8.

As used herein, the term a “software build” or a “build” generally refers to a process in which a software application or a part thereof is derived from source code for execution by one or more computing processors. In certain examples, performing a software build can include performing one or more of the following:
performing version control by, for example, creating and/or updating a workspace for the build, baselining source code, and reporting results of the build;
performing software analysis on, for example, adherence to metrics of code qualities including, for example, comments, unit tests, duplication, complexity, coding rules, potential code issues, architecture, and/or design;
compiling source code into machine executable or intermediate instructions.
   In other examples, performing a software build can also include using an interpreter associated with an interpreted programming language (e.g., Perl, ruby, or Python) to directly execute statements in source code without compilation. In further examples, performing a software build can also include performing software integration, version checking, and/or other suitable functions.

Also used herein, the term a “software builder” or a “builder” generally refers to a hardware/software component configured to perform a software build. In one example, a software builder can include a personal computer, a server, or other suitable types of computing device with suitable software provisions configured to perform a software build. In other examples, a software builder can also include a virtual machine hosted on a physical server and configured to perform a software build. In further examples, a software builder can be a cloud-based software service. One example builder is the Windows App Studio provided by Microsoft Corporation of Redmond, Wash.

As used herein, the term a “change” generally refers to a revision, addition, correction, or other suitable types of modification to source code of a software application. In one example, a change can include a bug fix. In another example, a change can include a new feature for the software application. In a further example, a change can include modification in structure and/or function of an existing feature of the software application.

The term a “main body” of a software application generally refers to a copy of a software application in source code that have been previously built and tested to ensure functionality and quality. In certain embodiments, the main body can be associated with a plurality of markers (e.g., build numbers) each indicating a milestone or checkpoint in the development of the main body. For instance, a marker can indicate a point at which certain documented changes have been applied to the main body. In other embodiments, the main body can be constantly updated with changes that have been built and tested.

Integrating separately developed branches into a main body of a software application can be challenging. The separately developed parts often do not function properly with one another even though each part functions correctly when executed or operated individually. Thus, considerable amount of time and efforts are needed in order to properly integrate all the separately developed branches. Several embodiments of the disclosed technology implement one or more sets of software builders that are each configured to directly apply changes to a main body of a software application. Each software builder can also build the software application with the applied changes for one or more computing platforms or flavors thereof. As such, changes to the main body can be continually tested. Any conflicts or other issues related to the particular changes can be identified during a software build for multiple computing platforms or flavors thereof. As a result, time-consuming integration and assembly of separately developed branches of a software application can be at least reduced if not eliminated.

FIGS. 1A and 1B are schematic diagrams illustrating a computing framework 100 for software build management in accordance with embodiments of the disclosed technology. As shown in FIG. 1A, the computing framework 100 can include one or more client devices 102, a builder set 104 having multiple builders 105, and a depot 114 operatively interconnected by a computer network 110. Even though particular components of the computing framework 100 are shown in FIGS. 1A and 1B, in other embodiments, the computing framework 100 can also include additional and/or different components. For example, two client devices 102 are shown in FIGS. 1A and 1B. In other embodiments, the computing framework 100 can include one, three, or any other suitable number of client devices 102.

The computer network 110 can include the Internet, a local area network, a metropolitan area network, a wide area network, and/or other suitable types of network. In the illustrated embodiment of FIGS. 1A and 1B, the computer network 110 is shown operatively interconnecting the client devices 102, the builder set 104, and the depot 114. In other embodiments, separate computer networks (not shown) may operatively connect the foregoing components of the computing framework 100. For example, the client devices 102 can be connected to the build set 104 via the Internet. The builder set 104 can be connected to the depot 114 via or a local area network having routers, switches, load balancers, firewalls, and/or other suitable network components.

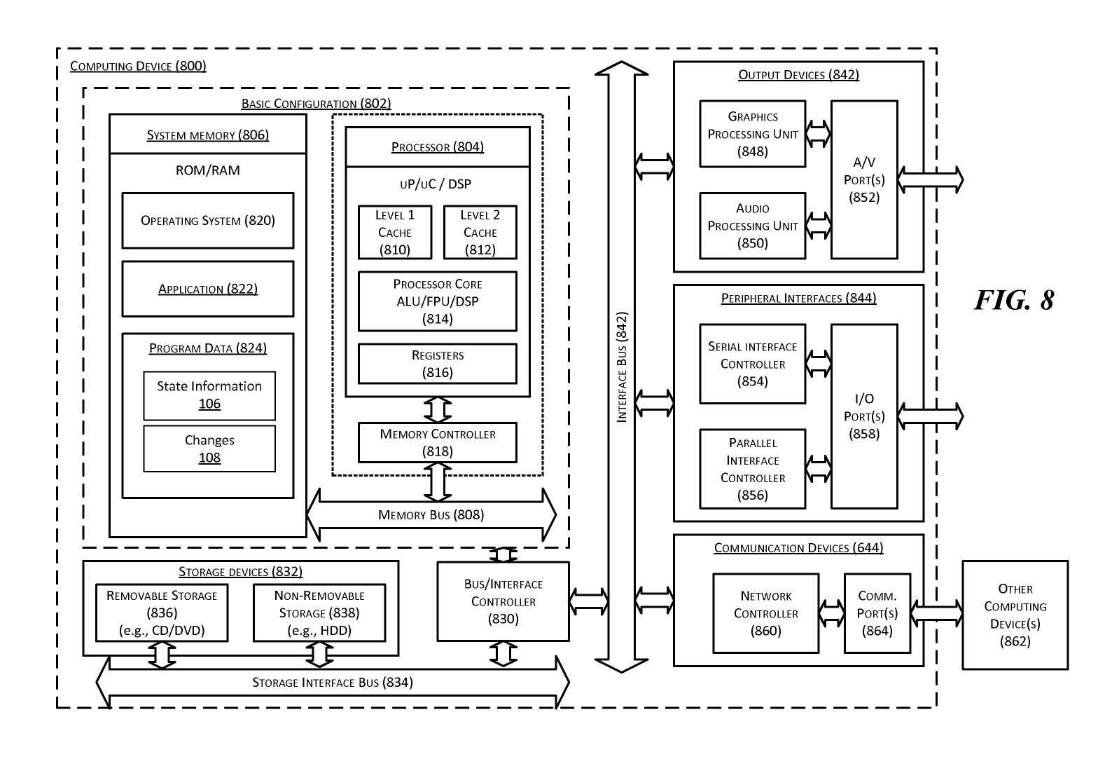

The client devices 102 can individually include a personal computer, a tablet, and/or other suitable types of computing devices. The client devices 102 can each include a processor and memory containing instructions for execution by the processor to provide facilities to respective users 101 for creating, constructing, and/or otherwise generating changes 108 designed to be applied to a main body 116 of a software application stored in the depot 114. One example computing device suitable for the client devices 102 is described below in more detail with reference to FIG. 8.

The depot 114 can be configured to store a main body 116 of a software application. In one embodiment, the depot 114 includes one or more file servers configured as network attached storage devices that provide data access to the builder set 104. In other embodiments, the depot 114 can include other suitable types of storage devices. In the illustrated embodiment of FIGS. 1A and 1B, the depot 114 is shown as being separate from the builder set 104. In further embodiments, the depot 114 can reside in one of the builders 105 of the builder set 104 or otherwise be integrated with the builder set 104.

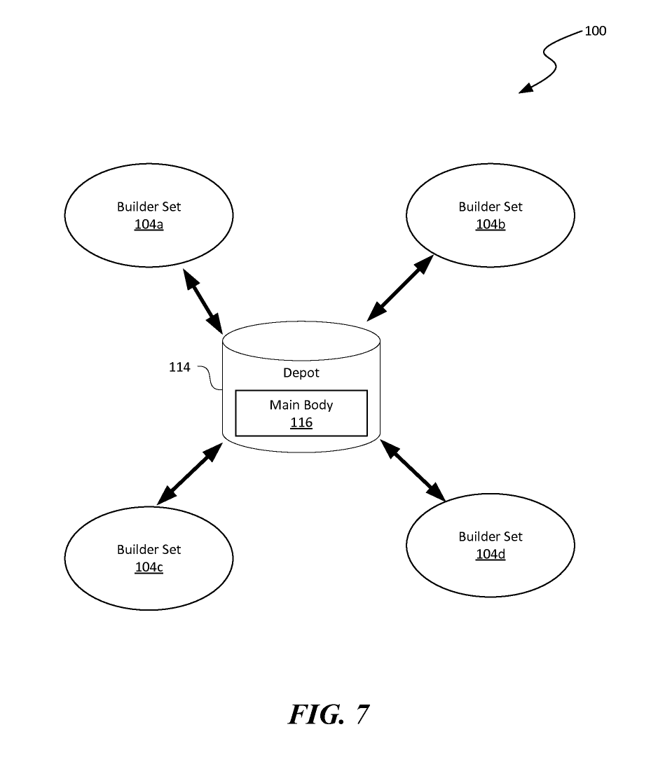

As shown in FIG. 1A, the builder set 104 can include a plurality of builders 105 (identified individually as first, second, and third builders 105a-105c, respectively) communicatively coupled to one another via the computer network 110. Even though three builders 105a-105c are shown in FIGS. 1A and 1B, in other embodiments, the builder set 104 can include two, four, or any suitable number of builders 105. In further embodiments, multiple builder sets 104 can be operatively coupled to the source code depot 114, as described in more detail below with reference to FIG. 7.

In certain embodiments, the builders 105 can be operatively arranged in a train-like structure. For example, the first builder 105a can be communicatively coupled to the second builder 105a, which in turn is communicatively coupled to the third builder 105c. In other embodiments, the builders 105 can be communicatively arranged in a tree-like structure. For example, the first builder 105a can be communicatively coupled to both the second and third builders 105b and 105c. In further embodiments, the builders 105 can be communicatively arranged in a star-like or other suitable types of structure (not shown).

Each of the builders 105 can be configured to apply received changes 108 from the client devices 102 to the main body 116 of the software application. For example, the builders 105 can modify a portion of the main body 116 based on the changes 108. In another example, the builders 105 can add a new feature or functionality to the main body 116 based on the changes 108. In further examples, the builders 105 can perform a combination of the foregoing operations and/or other suitable operations to the main body 116.

Each of the builders 105 can also be configured to perform a software build of the main body 116 with the applied changes 108 for one or more computing platforms and/or flavors thereof. As used herein, a “computing platform” can refer to a particular hardware architecture, an operating system, or a runtime library. Example hardware architecture can include Intel x86, Apple Macintosh, Qualcomm Snapdragon, or ARM. Example operating systems can include Linux, Microsoft Windows, OS X, Android, or iOS operating systems. Flavors of a computing platform can include different combinations of hardware architectures, operating systems, and runtime libraries. For example, Android operating system can have one flavor designed for x86 hardware architecture and another flavor designed for ARM hardware architecture.

In certain embodiments, each of the builders 105 can be configured to perform a software build of the main body 116 for a single computing platform or a flavor thereof. For instance, the first builder 105a can be configured to build the main body 116 for a 32-bit version of Windows (i.e., X86). The second builder 105b can be configured to build the main body 116 for a 64-bit version of Windows (i.e., X64). And the third builder 105c can be configured to build the main body 116 for the Apple iOS platform. In other embodiments, each of the builders 105 can be configured to build the main body 116 for multiple computing platforms and/or flavors thereof. In further embodiments, the builders 105 may be configured to perform software builds of the main body 116 in other suitable manners.

In the illustrated embodiment, the first builder 105a is shown as being configured to coordinate or manage a software build for the builder set 104. For example, the first builder 105a can be configured to receive the changes 108 from the client device 102 and store the received changes 108 thereon. The first builder 105a can also be configured to track state information 106 related to the main body 116 stored in the source code depot 114. In one embodiment, the state information 106 includes a current marker (e.g., a build number) associated with the main body 116. In other embodiments, the state information 106 can include other suitable metadata describing a current state, version, or condition of the main body 116. In further embodiments, other builders 105 can be configured to perform the foregoing functions instead of or in addition to the first builder 105.

In operation, users 101 can utilize the corresponding client devices 102 to generate one or more changes 108 designed to be applied to the main body 116. The client devices 102 can then transmit the generated changes 108 to the first builder 105a. The first builder 105a can then apply the changes 108 to the main body 116 based on various criteria. For example, the first builder 105a can apply the changes 108 before initiating a software build based on one or more of a time of day, a number of changes 108 received, upon receiving at least one change 108, upon receiving a user command, or based on other suitable criteria.

In certain embodiments, the first builder 105a can apply the changes 108 to the main body 116 based on a marker contained in the current state information 106. In other embodiments, the first builder 105a applies the changes 108 to the most current version of the main body 116. In yet further embodiments, the first builder 105a can apply the changes 108 to the main body 116 in other suitable manners. The first builder 105a can then initiate a software build of the main body 116 with the applied changes 108 for one or more computing platforms and/or flavors thereof.

In certain embodiments, the first builder 105a can also transmit the state information 106 and the changes 108 to the second builder 105b. The second builder 105b can then synchronize the copy of main body 116 contained thereon based on the received state information 106 and apply the received changes 108 to the synchronized copy of the main body 116. The second builder 105b then initiates a software build of the main body 116 with the applied changes 108 for one or more computing platforms and/or flavors thereof. The second builder 105b can also transmit the state information 106 and the changes 108 to the third builder 105c. The third builder 105c can then perform operations generally similar as does generally similarly to the second builder 105b though for different computing platforms and/or flavors thereof.

In other embodiments, the first builder 105a can transmit the state information 106 and the change 108 to both the second and third builders 105b and 105c. In turn, the second and third builders 105b and 105c can apply the changes 108 to the main body 116 and initiate respective software builds of the main body 116 with the applied changes 108 for one or more computing platforms and/or flavors thereof. In any of the foregoing embodiments, the builders 105 can perform software builds of the main body 116 that is at the same state with the same changes 108 applied thereto. The builders 105 can perform the software builds generally concurrently, sequentially, in an interleaved manner, or in other suitable manners.

After the builders 105 finish respective software builds of the main body 116, each of the builders 105 can generate a report of build results 112, as shown in FIG. 1B. The generated results 112 can indicate whether a software build is successful, issues or errors encountered during the software build, quality parameters of the software build, and/or other suitable information related to the software build. In the illustrated embodiment of FIG. 1B, the results 112 from the second and third builders 105b and 105c are transmitted to the first builder 105a, which in turn transmits the results 112 to the client devices 102. In another embodiment, the third builder 105c transmits the result 112 to the second builder 105b, which in turn transmits the results 112 to the first builder 105a. In other embodiments, each of the builders 105 can individually transmit the generated results 112 to the client devices 102.

In certain embodiments, the first builder 105a can also incorporate one or more changes 108 in source code into the main body 116 stored in the depot 114 based on the results 112. For example, in one embodiment, the first builder 105a can modify the main body 116 to incorporate the changes 108 when the first, second, and third builders 105a-105c all report success in their respective software builds. The first builder 105a can also update the state information 106 with, for example, a new marker associated with the incorporation of the changes 108 into the main body 116. In other embodiments, such incorporation of changes 108 may be performed manually by one of the users 101 and/or other suitable entities. In further embodiments, the builder set 104 can repeat the foregoing operations to process newly received changes 108.

Several embodiments of the disclosed technology can at least reduce if not avoid time-consuming branch integration. As discussed above, changes 108 in source code designed to be applied to the main body 116 can be repeatedly applied to the main body 116 upon which a software build is performed for various computing platforms or flavors thereof. As such, conflicts or other programming issues related to any of the changes 108 may be discovered and corrected before being integrated into the main body 116 of the software application. Thus, time-consuming branch integration can be reduced or even avoided.

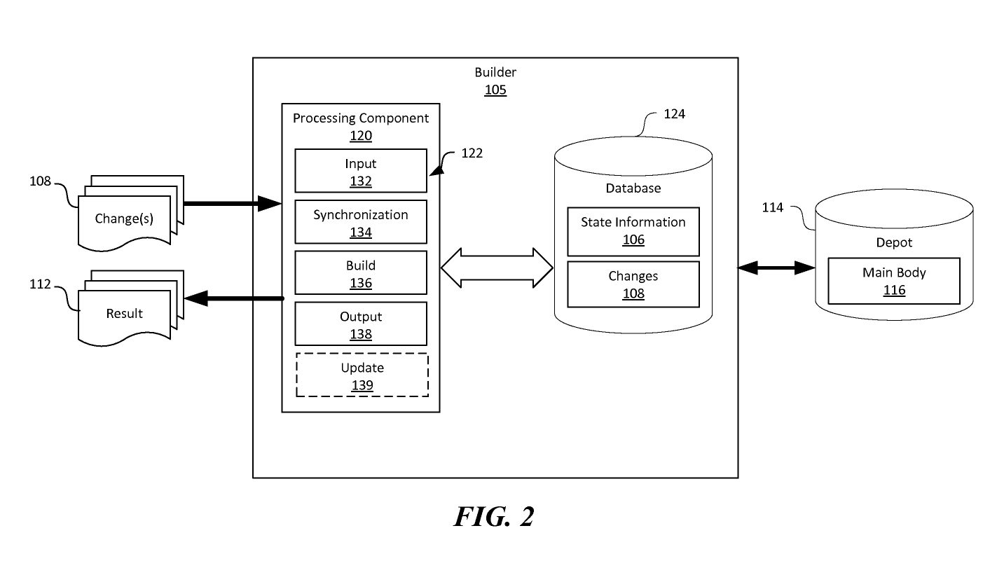

FIG. 2 is a block diagram showing software modules 122 suitable for a builder 105 of FIGS. 1A and 1B and in accordance with embodiments of the disclosed technology. In FIG. 2 and in other Figures hereinafter, individual software components, modules, and routines may be a computer program, procedure, or process written as source code in C, C++, Java, and/or other suitable programming languages. The computer program, procedure, or process may be compiled into object, intermediate, or machine code and presented for execution by one or more processors of a personal computer, a network server, a laptop computer, a smartphone, and/or other suitable computing devices. Various implementations of the source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2, the builder 105 can include a processing component 120 coupled to a database 124. The database 124 can include a persistent memory, a cache, and/or other suitable storage components configured to store received changes 108 and state information 106 associated with the main body 116. The processing component 120 can include a plurality of software modules 122 configured to facilitate computer software build management.

As shown in FIG. 2, the software modules 122 include an input module 132, a synchronization module 134, a build module 136, an output module 138, and an optional update module 139 operatively coupled to one another. In one embodiment, all of the software modules 122 can reside on a single computing device (e.g., a network server). In other embodiments, the software modules 122 can also reside on a plurality of distinct computing devices. In further embodiments, the software modules 122 may also include interface modules and/or other suitable types of modules.

The input module 132 is configured to receive one or more changes 108 from, for example, the client devices 102 (FIG. 1A) or another builder 105 (e.g., the first builder 105a of FIG. 1A). In one embodiment, the input module 132 includes a wired or wireless network interface controller. In other embodiments, the input module 132 can also include a virtual network interface and/or other suitable hardware/software interface components. The input module 132 can then store the received changes 108 in a database 124 operatively coupled to the processing component 120. The stored changes 108 can be arranged in a queue, stack, or other suitable arrangements.

The synchronization module 134 can be configured to transmit a synchronization command to other builders 105 (FIG. 1A) to synchronize state information 106 and/or the changes 108 in the database 124 of the builders 105. In one embodiment, one of the builders 105 (e.g., the first builder 105a in FIG. 1A) can transmit a synchronization command to a next builder 105 (e.g., the second builder 105b in FIG. 1A) based on, for example, a user input, a new incoming change 108, or other suitable criteria. In another embodiment, one of the builders 105 (e.g., the second builder 105b) can receive a synchronization command and retransmit the received synchronization command to another builder 105 (e.g., the third builder 105c in FIG. 1A). In further embodiments, one of the builders 105 (e.g., the first builder 105a) can transmit a synchronization command individually to at least some of the other builders 105 (e.g., second and third builders 105b and 105c).

The synchronization module 134 can also be configured to perform the synchronization of state information 106 and/or the changes 108 at the builders 105 based on the synchronization command. In one embodiment, the synchronization module 134 can be configured to synchronizing copies of the main body 116 at different builders 105 to be associated with the same marker. In another embodiment, the synchronization module 134 can be configured to remove any previous or otherwise non-suitable changes 108 based on the state information 106. For example, the synchronization module 134 can remove any changes 108 that have already been applied to the main body 116 or otherwise inconsistent with the main body 116 based on a marker contained in the state information 106.

The build module 136 can be configured to perform a software build of the main body 116 with the applied changes 108 for one or more computing platforms and/or flavors thereof on one of the builders 105 independent from other builders 105. In certain embodiments, the build module 136 can be configured to perform a software build for a computing platform or flavor thereof designated by a user or other suitable entities. In other embodiments, the build module 136 may be assigned to perform a software build for a randomly selected computing platform or flavor thereof. In further embodiments, the build module 136 can be configured to perform a software build for one or more computing platforms and/or flavors thereof selected in other suitable manners.

The output module 138 can be configured to generate one or more results 112 (FIG. 1B) based on a software build performed by the build module 136. In one embodiment, the output module 138 can be configured to generate an email indicating whether a software build is successful, stating issues or errors encountered during the software build, and/or reporting other suitable information related to the software build. In other embodiments, the output module 138 can be configured to generate an instant message, a text message, or other suitable types of messages. In further embodiments, the output module 138 can also be configured to transmit a copy of the state information 116 and/or a copy of the changes 108 to other builders 105.

The optional update module 139 can be configured to incorporate the changes 108 into the main body 116 based on the results 112 of the software build. For example, in certain embodiments, the output module 138 can be configured to modify the main body 116 in the depot 114 based on the changes 108 in response to an indication that the software build is successful, that a predetermined quality level associated with the changes 108 is met, or other suitable criteria. In other embodiments, the update module 139 may be omitted, and the main body 116 in the depot 114 may be updated manually or in other suitable manners.

In operation, the input module 132 receives the changes 108 and stores the changes 108 in the database 124. Upon a decision to synchronize with other builders 105, the synchronization module 134 can synchronize the state information 106 and the changes 108 with other builders 105. Upon another decision to initiate a software build, the build module 136 applies the changes 108 to a copy of the main body 116 and initiates a software build of the main body 116 with the applied changes 108. The output module 138 can then generate and transmit result 112 to the client devices 102, other builders 105, and/or other suitable entities. In certain embodiments, the output module 138 can also modify the main body 116 in the depot 114 based on the result 112 from current and/or other builders 105. In other embodiments, the copy of main body 116 can be updated to incorporate the changes 108 manually or in other suitable manners.

Even though particular modules 122 of the builder 105 are illustrated in FIG. 2, in certain embodiments, the processing component 120 of the builder 105 can include different combination of some of the software modules 122. For example, in one embodiment, the synchronization module 134 can be omitted. Instead, the builder 105 (e.g., the second builder 105b in FIG. 1A) relies upon the changes 108 received via the input module 132 from, for example, the first builder 105a of FIG. 1A for synchronization.

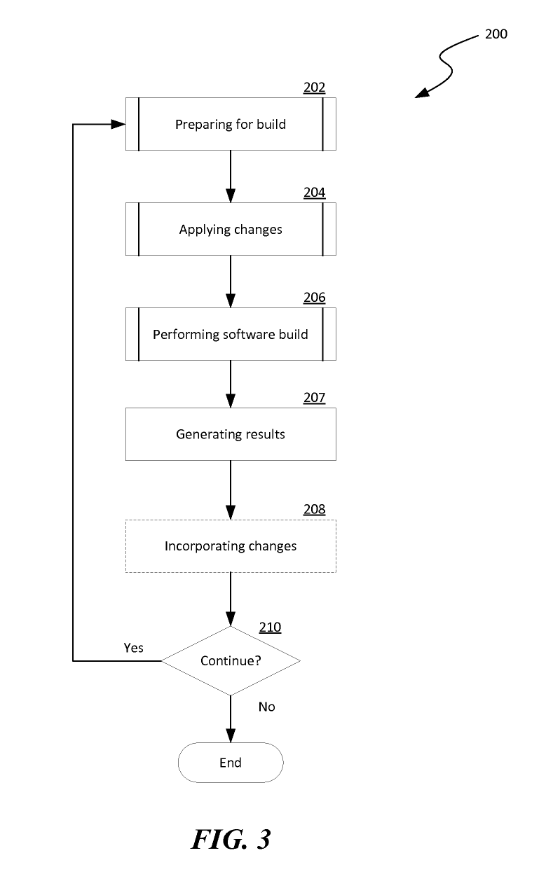

FIG. 3 is a flow diagram illustrating embodiments of a process 200 of computer software build management in accordance with embodiments of the disclosed technology. Even though various embodiments of the process 200 are described below with reference to the computing framework 100 of FIGS. 1A and 1B and the software modules 122 of FIG. 2, in other embodiments, the process 200 may be performed with other suitable types of computing frameworks, systems, components, or modules.

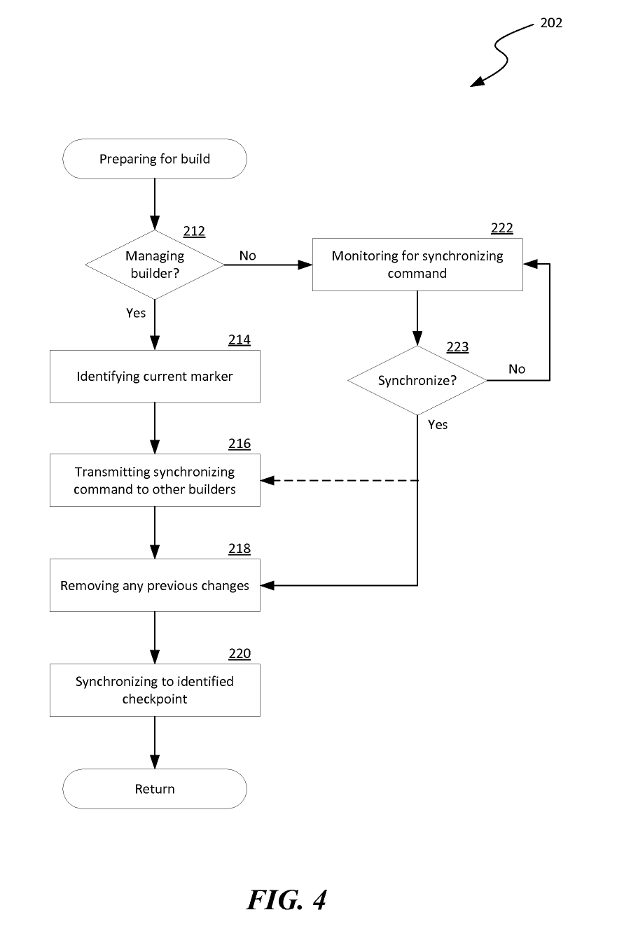

As shown in FIG. 3, the process 200 can include preparing for a software build at stage 202. In certain embodiments, preparing for a software build can include synchronizing copies of the main body 116 (FIG. 1A) at different builders 105 (FIG. 1A) to be at a single marker by utilizing, for example, the synchronization module 134 of FIG. 2. For example, copies of the main body 116 at each of the builders 105 can all be associated with a checkpoint number, a build number, a version number, a release number, or other suitable identification number. In another example, copies of the main body 116 at each of the builders 105 can all be a copy of the most recently updated main body 116. Other example operations of preparing for a software build are described in more detail below with reference to FIG. 4.

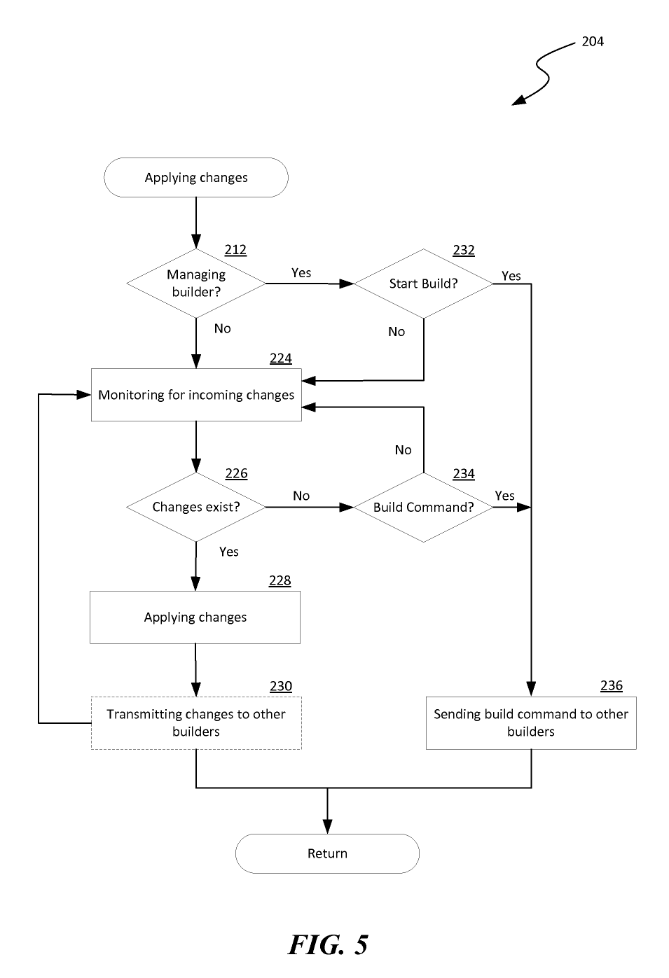

The process 200 can then include applying one or more changes 108 (FIG. 1A) to the main body 116 of the software application at stage 204. In one embodiment, applying one or more changes 108 can include receiving one or more changes 108 from, for example, the client devices 102 (FIG. 1A) or other builders 105 (FIG. 1A) via the input module 132 (FIG. 2). The received changes 108 can then be applied to the main body 116. In other embodiments, the received changes 108 may be applied based on a number of received changes 108, time of day, user input, or other suitable criteria. Other example operations of applying one or more changes 108 are described in more detail below with reference to FIG. 5.

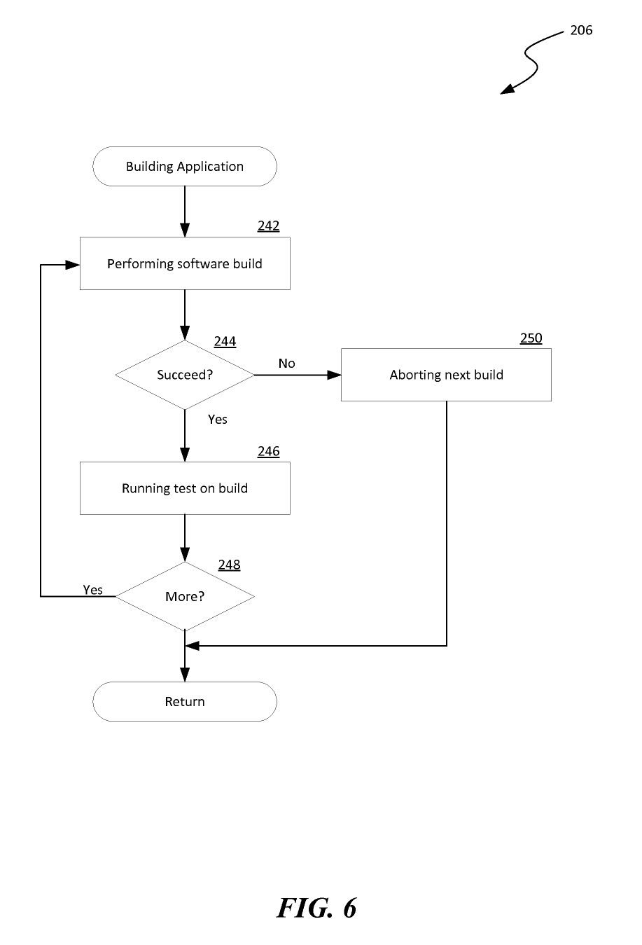

The process 200 can also include performing multiple software builds on the main body 116 with the applied changes 108 at multiple builders 105 at stage 206. In certain embodiments, performing the software builds can include generally concurrently performing multiple software builds at different builders 105 corresponding to multiple computing platforms and/or flavors thereof. In other embodiments, at least some of the software builds can be performed in sequence, in an interleaved manner, or in other suitable manners. Example operations of performing multiple software builds on one builder 105 are described in more detail below with reference to FIG. 6.

The process 200 can then include generating results associated with the software builds, for example, by utilizing the output module 138 of FIG. 2 at stage 207. The process 200 can optionally include incorporating the changes 108 in source code into a copy of the main body 116 in the depot 114 (FIG. 1A) utilizing, for example, the update module 139 in FIG. 2 at stage 208. In one embodiment, one of the builders 105 (e.g., the first builder 105a in FIG. 1A) can modify the copy of main body 116 in the depot 114 based on the results 112 (FIG. 1B). In other embodiments, a user 101 (FIG. 1A) or other suitable entities can perform such modification based on the results 112 and/or other suitable criteria. In further embodiments, operations related to stage 208 may be omitted.

The process 200 can then include a decision stage 210 to determine if the process continues. In one embodiment, the process can be terminated when, for example, no changes 108 have been received for a predetermine period of time. In other embodiments, the process can be terminated based on other suitable criteria. In response to determining that the process continues, the process reverts to preparing for a software build at stage 202; otherwise, the process ends.

FIG. 4 is a flow diagram illustrating embodiments of a process 202 of preparing for a software build in accordance with embodiments of the disclosed technology. As shown in FIG. 4, the process 202 can include a decision stage 212 to determine if a particular builder 105 (FIG. 1A) is a managing builder configured to manage software builds on multiple builders 105 or a secondary builder. In the illustrated example in FIG. 1A, the first builder 105a (FIG. 1A) is the managing builder, and the second and third builders 105b and 105c (FIG. 1A) are secondary builders.

In response to determining that the builder is a managing builder, the process 202 includes identifying a current marker (e.g., a checkpoint or build number) associated with the main body 116 (FIG. 1A) in the depot 114 (FIG. 1A). The process 202 can then include transmitting, for example, from the first builder 105a, a synchronizing command to other builders (e.g., the second builder 105b) at stage 216. The process 202 can also include removing any previous or otherwise non-suitable changes 108 (FIG. 1A) based on the identified current marker at stage 218. As such, the copy of the main body 116 on the builder is synchronized to the identified marker at stage 220.

In response to determining that the builder is not a managing builder, the process 202 includes waiting for a synchronizing command at stage 222. The process 202 then includes a decision stage 223 to determine whether to synchronize. In response to receiving a synchronizing command, in one embodiment, the process 202 includes transmitting another synchronizing command (e.g., from the second builder 105b of FIG. 1A) to other builders (e.g., the third builder 105c of FIG. 1A). In other embodiments, the process 202 can include skipping the operations at stage 216 and proceeding to removing any previous or otherwise non-suitable changes 108 based on the identified current marker at stage 218.

FIG. 5 is a flow diagram illustrating embodiments of a process 204 of applying changes for a software build in accordance with embodiments of the disclosed technology. As shown in FIG. 5, the process 204 can include a decision stage 212 to determine if a builder is a managing builder, as described in more detail above with reference to FIG. 4. In response to determining that the builder is a managing builder, the process 204 includes another decision stage 232 to determine whether to start a software build. In one embodiment, a software build can start upon receiving at least one or a predetermined number of changes 108 (FIG. 1A). In another embodiment, a software build can start at a time of day, a day of week, or other suitable timing point. In further embodiments, a software build can start based on user input or other suitable criteria. In response to determining that a software build is to be started, the process 204 then proceeds to sending a build command to other builders 105 at stage 236, for example, from the first builder 105a of FIG. 1A to the second builder 105b of FIG. 1A.

In response to determining that the builder is not a managing builder or that a software build is not to be started, the process 204 then proceeds to monitoring for incoming changes 108 FIG. 1A at stage 224. In one embodiment, incoming changes 108 can be from the client device 102 (FIG. 1A). In another embodiment, incoming changes 108 can be from other builders 105 (FIG. 1A). In further embodiments, incoming changes 108 can be from other suitable sources.

The process 204 can then include a decision stage 226 to determine if any incoming changes 108 have been received. In response to determining that changes 108 exist, the process 204 includes applying the changes 108 to the synchronized copies of main body 116 (FIG. 1A) at stage 228. The process 204 can the optionally include transmitting the changes 108 to other builders 105, for example, from the first builder 105a to the second builder 105b in FIG. 1A.

The process then reverts to monitoring for incoming changes 108 at stage 224. In response to determining that changes 108 do not exist, the process 204 includes another decision stage 234 to determine if a build command has been received. In response to determining that a build command has been received, the process 204 proceeds to sending a build command to other builders 105 at stage 236; otherwise, the process 204 reverts to monitoring for incoming changes at stage 224.

FIG. 6 is a flow diagram illustrating embodiments of a process 206 of performing a software build in accordance with embodiments of the disclosed technology. As shown in FIG. 6, the process 206 includes performing a software build of the main body 116 (FIG. 1A) with the applied changes 108 (FIG. 1A) at stage 242. The process 206 then includes a decision stage 244 to determine if the software build has succeeded. In one embodiment, a software build is deemed to be successful when no errors or issues were encountered during the software build. In other embodiments, a software build can be deemed to be successful even though certain errors and/or issued were encountered during the software build. In further embodiments, a software build is deemed to be successful based on other suitable criteria.

In response to determining that the software build did not succeed, the process 206 proceeds to aborting any next software build at the particular builder 105 (FIG. 1A). In response to determining that the software build succeeded, the process 206 proceeds to running tests on the software build at stage 246. Example tests that can be performed at this stage include build verification, build acceptance test, and/or other suitable tests. The process 206 can then include a decision stage 248 to determine if there are additional software builds corresponding to other computing platforms and/or flavors thereof. In response to determining that there are additional software builds, the process 206 reverts to performing another software build at stage 242.

Even though only one build set 104 is shown in FIGS. 1A and 1B, in other embodiments, the computing framework 100 can include multiple builder sets 104 operatively coupled to the depot 114. For example, as shown in FIG. 7, four builder sets 104a-104d are shown to be operatively coupled to the depot 114 storing the main body 116 of a software application. The individual builder sets 104a-104d can be generally similar to the builder set 104 shown in FIG. 1A or can include additional and/or different components. In further embodiments, the computing framework 100 can include two, three, five, or any other suitable number of builder sets 104. In operation, the builder sets 104a-104d can perform software builds concurrently, serially, or in other suitable orders.

FIG. 8 is a computing device 800 suitable for certain components of the computing framework 100 in FIGS. 1A and 1B. For example, the computing device 800 may be suitable for the computing device 102 of FIG. 1A, or one of the builders 105 of FIG. 1A. In a very basic configuration 802, computing device 800 typically includes one or more processors 804 and a system memory 806. A memory bus 808 may be used for communicating between processor 804 and system memory 806.

Depending on the desired configuration, the processor 804 may be of any type including but not limited to a microprocessor (μP), a microcontroller (μC), a digital signal processor (DSP), or any combination thereof. The processor 804 may include one more levels of caching, such as a level one cache 810 and a level two cache 812, a processor core 814, and registers 816. An example processor core 814 may include an arithmetic logic unit (ALU), a floating point unit (FPU), a digital signal processing core (DSP Core), or any combination thereof. An example memory controller 818 may also be used with processor 804, or in some implementations memory controller 818 may be an internal part of processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, one or more applications 822, and program data 824. The program data 824 may include, for example, the state information 106 and the changes 108. This described basic configuration 802 is illustrated in FIG. 8 by those components within the inner dashed line.

The computing device 800 may have additional features or functionality, and additional interfaces to facilitate communications between basic configuration 802 and any other devices and interfaces. For example, a bus/interface controller 830 may be used to facilitate communications between the basic configuration 802 and one or more data storage devices 832 via a storage interface bus 834. The data storage devices 832 may be removable storage devices 836, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 806, removable storage devices 836, and non-removable storage devices 838 are examples of computer readable storage media. Computer readable storage media include storage hardware or device(s), examples of which include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which may be used to store the desired information and which may be accessed by computing device 800. Any such computer readable storage media may be a part of computing device 800. The term “computer readable storage medium” excludes propagated signals and communication media.

The computing device 800 may also include an interface bus 840 for facilitating communication from various interface devices (e.g., output devices 842, peripheral interfaces 844, and communication devices 846) to the basic configuration 802 via bus/interface controller 830. Example output devices 842 include a graphics processing unit 848 and an audio processing unit 850, which may be configured to communicate to various external devices such as a display or speakers via one or more AN ports 852. Example peripheral interfaces 844 include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which may be arranged to facilitate communications with one or more other computing devices 862 over a network communication link via one or more communication ports 864.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 800 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method for managing computer software builds, comprising:
synchronizing copies of source code of a software application at a plurality of software builders, the software builders individually having one or more computing processors and communicatively coupled to one another via a computer network;
applying a change in source code to each of the synchronized copies of source code of the software application at the individual software builders, the applied change being the same at each of the plurality of software builders; and
performing, at the individual software builders, a software build of one of the copies of source code of the software application with the applied change for a computing platform, wherein the computing platforms corresponding to the plurality of software builders are different from one another.

2. The method of claim 1 wherein synchronizing copies of the source code of the software application includes synchronizing copies of the source code of the software application based on a marker associated with the copies of the source code, the marker including at least one of a build number, a checkpoint number, a version number, or a release number, wherein the synchronized copies of the source code of the software application at the plurality of software builders have the same marker.

3. The method of claim 1 wherein synchronizing copies of the source code of the software application includes synchronizing copies of the source code of the software application based on a marker associated with the copies of the source code and removing other changes inconsistent with the copies of source code corresponding to the marker.

4. The method of claim 1 wherein individually performing the software build includes generally concurrently performing the software builds at each of the plurality of software builders.

5. The method of claim 1 wherein individually performing the software build includes generally concurrently performing the software builds at each of the plurality of software builders for a corresponding a hardware architecture, an operating system, or a runtime library.

6. The method of claim 1 wherein individually performing the software build includes generally concurrently performing the software builds at each of the plurality of software builders for a corresponding combination of at least some of a hardware architecture, an operating system, or a runtime library.

7. The method of claim 1, further comprising generating results of the performed software builds from each of the plurality of software builders.

8. The method of claim 1, further comprising:
generating results of the performed software builds from each of the plurality of software builders; and
automatically incorporating the applied change into a copy of the source code in a source code depot based on the generated results of the performed software builds.

9. A computing device having a processor and memory, the computing device comprising:
an input module configured to receive a change to be applied to a copy of source code of a software application;
a synchronization module configured to synchronize a copy of the source code at the computing device with other copies at other computing devices communicatively coupled to the computing device via a computer network; and
a build module configured to:
apply the received change to the synchronized copy of the source code; and
perform a software build on the synchronized copy of the source code with the applied change for a computing platform, wherein the computing platform being different from other computing platforms individually associated with the other computing devices.

10. The computing device of claim 9 wherein the input module is configured to receive the change to be applied to the copy of source code of the software application from a user via a client device or one of the other computing devices.

11. The computing device of claim 9 wherein the synchronization module is configured to synchronize the copy of the source code at the computing device with other copies at the other computing devices based on state information associated with the source code and stored in the computing device, the state information including a build number, a checkpoint number, a version number, or a release number.

12. The computing device of claim 9 wherein the build module is configured to perform the software build on the synchronized copy of the source code with the applied change for the computing platform independently from software builds performed on the other computing devices.

13. The computing device of claim 9, further comprising an output module configured to transmit the copy of the source code and a copy of the received change to at least one of the other computing devices.

14. The computing device of claim 9, further comprising an output module configured to generate a result related to the software build performed by the build module, the result indicating whether the performed software build succeeded.

15. The computing device of claim 9, further comprising:
an output module configured to generate a result regarding the software build performed by the build module, the result indicating whether the performed software build succeeded; and
an update module configured to update a copy of the source code in a source code depot with the received change based on the generated result regarding the software build performed by the build module.

16. The computing device of claim 9 wherein the synchronization module is configured to synchronize the copy of the source code at the computing device with other copies at the other computing devices based on at least one of a build number, a checkpoint number, a version number, or a release number associated with the source code, and the computing device further includes:
an output module configured to generate a result regarding the software build performed by the build module, the result indicating whether the performed software build succeeded; and
an update module configured to:
update a master copy of the source code in a source code depot with the received change based on the generated result regarding the software build; and
update the at least one of the build number, the checkpoint number, the version number, or the release number to correspond to the updated master copy.

17. A computing system, comprising:
a plurality of software builders communicatively coupled via a computer network, the plurality of software builders are individually configured to:
receive a change to be applied to a copy of source code of a software application;
apply the received change to the synchronized copy of the source code; and
independently perform a software build on the copy of the source code with the applied change for a computing platform; and
wherein the copies of the source code and the changes applied at the plurality of builders are the same, and wherein the computing platforms at the plurality of builders are different from one another.

18. The computing system of claim 17 wherein one of the software builders is configured to synchronize the copies of the source code at the plurality of software builders based on at least one of a build number, a checkpoint number, a version number, or a release number associated with the source code prior to performing the software builds at the plurality of software builders.

19. The computing system of claim 17 wherein:
the software build is a first software build;
the plurality of software builders are also configured to:
individually performing a second software build subsequent to the first software build, the second software build corresponding to a computing platform different than that corresponding to the first software build;
determining whether the first software build succeeded; and
in response to determining that the first software build is not succeeded, aborting the second software build.

20. The computing system of claim 17 wherein:
a first one of the software builders is configured to receive the change from a client device and determine a current version of the copy of the source code;
a second one of the software builders is configured to receive, from the first one of the software builders, the change and the determined current version of the copy of the source code; and
a third one of the software builders is configured to receive, from the second one of the software builders, the change and the determined current version of the copy of the source code.
